(19) United States
(12) Patent Application Publication
(10) Pub. No.: US 2019/0228413 A1
(43) Pub. Date: Jul. 25, 2019

(54) AUDITING EQUIPMENT, ANONYMOUS REMITTANCE METHOD WITH AUDIT FUNCTION, AND STORAGE MEDIUM

(71) Applicant: Hitachi, Ltd., Tokyo (JP)

(72) Inventors: Ken NAGANUMA, Tokyo (JP); Hisayoshi SATO, Tokyo (JP)

(21) Appl. No.: 16/313,484

(22) PCT Filed: Mar. 22, 2017
(86) PCT No.: PCT/JP2017/011453

§ 371 Date: Dec. 27, 2018

(30) Foreign Application Priority Data
Jul. 7, 2016 (JP) 2016-134911

(51) Int. Cl. G06Q 20/40; G06Q 20/38; H04L 9/32

(52) U.S. Cl. CPC G06Q 20/407; G06Q 20/38215; G06Q 20/383; H04L 9/3218; H04L 9/3252

(57) ABSTRACT

This auditing equipment includes a processor and a memory. The processor accepts a first transaction including information pertaining to a remittance source, an electronic value, and a cipher text, accepts a second transaction including information pertaining to a remittance destination, the electronic value, and a first preimage value, calculates a first plain text using a prescribed parameter and the first preimage value in the second transaction, calculates a second plain text by decrypting the cipher text in the first transaction, compares the first plain text to the second plain text, and associates the information pertaining to the remittance source in the first transaction with the information pertaining to the remittance destination in the second transaction if the first plain text matches the second plain text.

### CLAIM OF PRIORITY

The present application claims priority from Japanese patent application JP 2016-134911 filed on Jul. 7, 2016, the content of which is hereby incorporated by reference into this application.

### BACKGROUND

This invention relates to a transaction transmission method for anonymizing remittance information on virtual currency from a third person on a distributed ledger, and at the same time disclosing the remittance information to an auditor.

In recent years, commercial transactions using electronic money or virtual currency have been conducted in addition to the transactions of commodities by real currency. In S. Nakamoto: “A Peer-to-Peer Electronic Cash System”, [online], [retrieved on Jul. 1, 2016], Internet, <URL: https://bitcoin.org/bitcoin.pdf>, there is disclosed a technology of settling transaction at low fees without requiring a centralized organization, for example, a bank, by using virtual currency called “Bitcoin”.

In the Bitcoin technology, a node called “miner” determines validity of transaction information (hereinafter also referred to as “transaction”) on a peer-to-peer (P2P) network, and then processing of establishing transaction is executed in an operation of calculating a specific hash value called “proof of work”. The established transaction is aggregated into one block, and is recorded in a distributed ledger called “block chain”.

All the nodes on the P2P network can refer to the transactions and distributed ledger of Bitcoin, and thus can refer to one node that has remitted Bitcoin money and another node that has received the Bitcoin money. As a result, when the Bitcoin addresses of users are known, information on transactions between those users are also easily viewed by a third person.

In order to address this issue, in Ian Miers, Christina Garman, Matthew Green, and Aviel D. Rubin: “Zerocoin: Anonymous Distributed E-Cash from Bitcoin”, IEEE Computer Society Conference Publishing Services, pp. 397-411 (hereinafter referred to as “Non-Patent Literature 2”), there is proposed a scheme of using a coin for anonymous remittance called “Zerocoin” on the Bitcoin protocol. In the scheme of Zerocoin, transaction with a commitment called “Zerocoin” is broadcasted to the P2P network without a remitter node specifying a remittee (recipient) node. The remittee broadcasts transaction with zero-knowledge proof for verifying that the recipient holds a pre-image of any commitment of Zerocoin on the P2P network without specifying a remitter, to thereby be able to disconnect a connection between the remitter and the remittee on the distributed ledger and implement anonymous remittance. Calculation of a zero-knowledge proof value is also described in Ronald Cramer, Ivan Damgard, and Berry Schoenmakers: “Proofs of Partial Knowledge and Simplified Design of Witness Hiding Protocols”, Advances in Cryptology—CRYPTO '94 LNCS, Volume 839, pp. 174-187 (hereinafter referred to as “Non-Patent Literature 3”).

### SUMMARY

In Non-Patent Literature 2 described above, there is a problem in that the transaction is anonymized on the distributed ledger and thus cannot be audited. As a result, in Non-Patent Literature 2, there is a problem in that a remittance history and other records cannot be traced even at the time of illegal remittance, for example, money laundering.

A representative aspect of this invention is as follows. An auditing apparatus, comprising a processor and a memory. The processor receives first transaction including remittance source information, an electronic value and an encrypted text. The processor receives second transaction including remittance destination information, the electronic value and a first pre-image. The processor calculates a first plain text based on a predetermined parameter and the first pre-image of the second transaction. The processor calculates a second plain text by decrypting the encrypted text of the first transaction. The processor compares the first plain text with the second plain text to associate the remittance source information of the first transaction with the remittance destination information of the second transaction when the first plain text matches the second plain text.

According to one embodiment of this invention, a computer other than the auditing apparatus can remit money by anonymizing transaction. On the other hand, the auditing apparatus can remove the anonymity to trace the remittance history and other records. Further, the auditing apparatus does not have an authority to stop remittance itself or freeze an account unlike the case of a central organization, for example, an existing bank. Thus, the freedom of remittance is secured.

### BRIEF DESCRIPTION OF THE DRAWINGS

FIG. 1 is a block diagram for illustrating an exemplary configuration of the anonymous remittance system with an audit function in a first embodiment of this invention.

FIG. 2 is a block diagram for illustrating an exemplary hardware configuration of the user terminal in the first embodiment of this invention.

FIG. 3 is a sequence diagram for illustrating an example of processing of preliminary key distribution among the user terminal in the first embodiment of this invention.

FIG. 4 is a sequence diagram for illustrating an example of processing of data transmission and reception in the first embodiment of this invention.

FIG. 5 is a table for showing an exemplary data format of the anonymous remittance transaction in the first embodiment of this invention.

FIG. 6 is a table for showing an exemplary data format of the money reception token in the first embodiment of this invention.

FIG. 7 is a flowchart for illustrating details of the anonymous remittance transaction generation processing in the first embodiment of this invention.

FIG. 8 is a table for showing an exemplary data format of the anonymous money reception transaction in the first embodiment of this invention.

FIG. 9 is a flowchart for illustrating details of the anonymous money reception transaction generation processing in the first embodiment of this invention.

FIG. 10 is a flowchart for illustrating details of the anonymity removal processing in the first embodiment of this invention.

FIG. 11 is a block diagram for illustrating an example of an anonymous remittance system with an audit function in a second embodiment of this invention.

### DETAILED DESCRIPTION OF THE PREFERRED EMBODIMENTS

Now, a description is given in detail of an anonymous remittance system with an audit function in one embodiment of this invention with reference to the drawings.

### First Embodiment

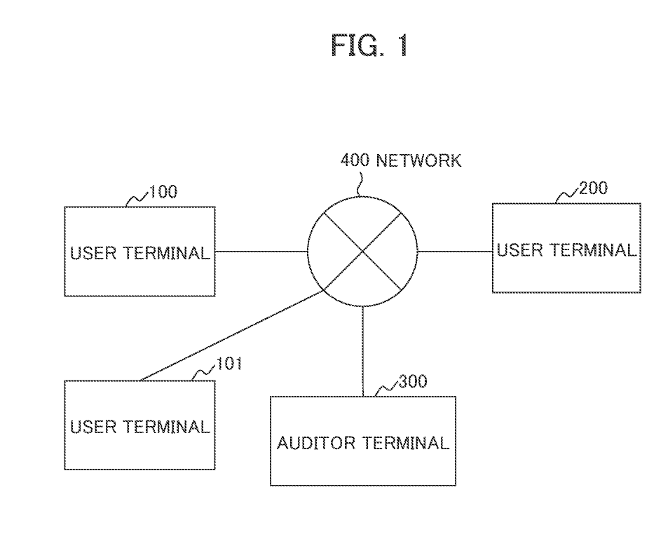

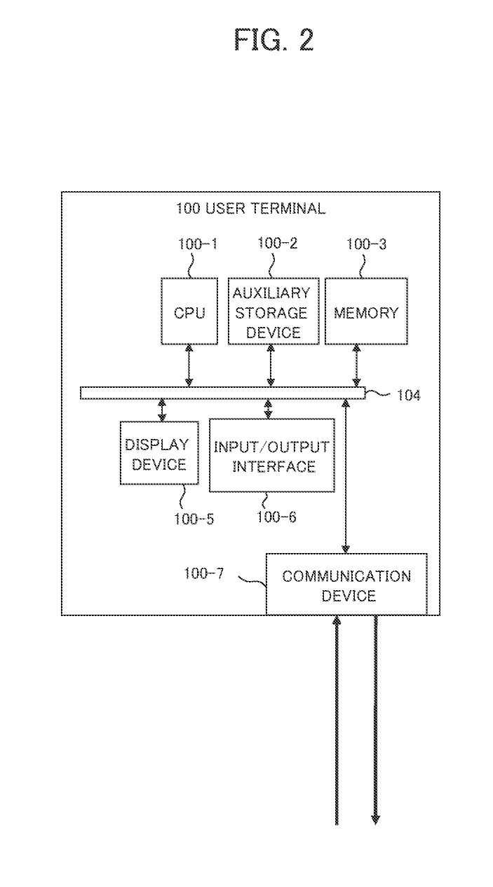

In the following, referring to FIG. 1 and FIG. 2, a description is given of an exemplary configuration of an anonymous remittance system with an audit function in a first embodiment of this invention.

FIG. 1 is a block diagram for illustrating an exemplary configuration of the anonymous remittance system with an audit function in the first embodiment of this invention. As illustrated in FIG. 1, the anonymous remittance system with an audit function is designed to include a user terminal 100, a user terminal 101, a user terminal 200, and an auditor terminal 300, which are configured to transmit/receive information to/from one another via a network 400.

FIG. 2 is a block diagram for illustrating an exemplary hardware configuration of the user terminal 100. As illustrated in FIG. 2, the user terminal 100 includes a CPU 100-1, an auxiliary storage device 100-2, a memory 100-3, a display device 100-5, an input/output interface 100-6, and a communication device 100-7, which are coupled to one another via an internal signal line 100-4.

Further, the auxiliary storage device 100-2 stores a program code. The program code is loaded into the memory 100-3 and executed by the CPU 100-1. The user terminal 101, the user terminal 200, and the auditor terminal 300 have similar hardware configurations.

In the first embodiment, the user terminals 100, 101, and 200, and the auditor terminal 300 execute a key pair generation program, the user terminals 100 and 101 execute a remittance program, the user terminal 200 executes a reception program, and the auditor terminal 300 executes an audit program.

Now, terms to be used in the first embodiment are defined.

(1) Public Key/Private Key Pair of Public-Key Cryptography in Discrete Group

In the first embodiment, an ElGamal encryption system is used for public-key encryption. In the ElGamal encryption, a discrete group G of an order p for which a discrete logarithm is difficult to calculate and a generator f thereof are set as public system parameters, a secret key is set as a random integer x, a public key is set as the generator f to the power of x, namely, f^{x}, and a public key/private key pair (e, x) is set as (f^{x}, x). Further, an encrypted text Enc(e, m) generated by the public key e of a plain text m is set as Enc(e, m)=(f^{r}, e^{r}m) by using a random number r.

(2) Three Generators (f, g, h) of Discrete Group

In the first embodiment, the discrete group G has g and h as its generators in addition to f described above, and those three different generators f, g, and h are set as public system parameters. Further, f, g, and h are randomly generated at the time of starting the system, and it is assumed that it is difficult to calculate discrete logarithms such as the discrete logarithm of f with respect to g and the discrete logarithm of h with respect to g.

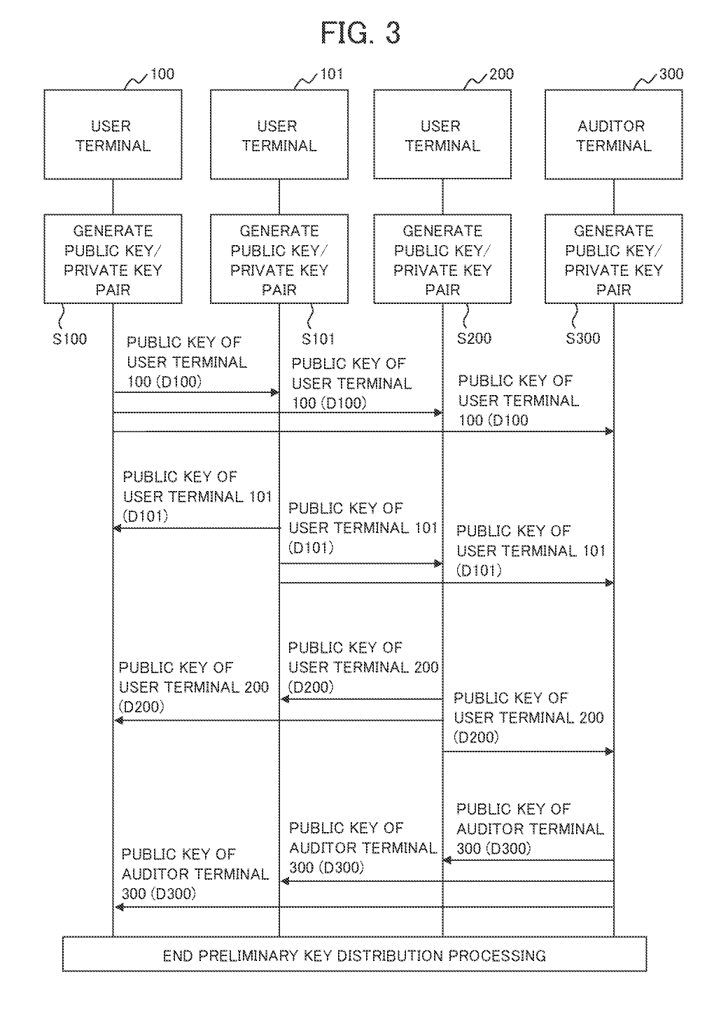

FIG. 3 is a sequence diagram for illustrating an example of data transmission/reception and processing of preliminary key distribution among the user terminal 100, the user terminal 101, the user terminal 200, and the auditor terminal 300.

First, the user terminal 100 executes a public key/private key pair generation program to generate a public key and a private key corresponding to the public key (Step S100). A publicly known or widely known technology may be applied to a technique of generating a pair of the public key and the private key, and thus details thereof are not described in the first embodiment. Similarly, the user terminal 101 executes the public key/private key pair generation program to generate a public key and a private key corresponding to the public key (Step S101). Similarly, the user terminal 200 executes the public key/private key pair generation program to generate a public key and a private key corresponding to the public key (Step S200). Similarly, the auditor terminal 300 executes the public key/private key pair generation program to generate a public key and a private key corresponding to the public key (Step S300).

Next, the user terminal 100 transmits the public key (D100) generated in Step S100 to the user terminal 101, the user terminal 200, and the auditor terminal 300.

Next, the user terminal 101 transmits the public key (D101) generated in Step S101 to the user terminal 100, the user terminal 200, and the auditor terminal 300.

Next, the user terminal 200 transmits the public key (D200) generated in Step S200 to the user terminal 100, the user terminal 101, and the auditor terminal 300.

Next, the auditor terminal 300 transmits the public key (D300) generated in Step S300 to the user terminal 100, the user terminal 101, and the user terminal 200, to end the preliminary key distribution processing. With this processing, the user terminals 100, 101, and 200 and the auditor terminal 300 have generated public keys and private keys, and those public keys are distributed to one another.

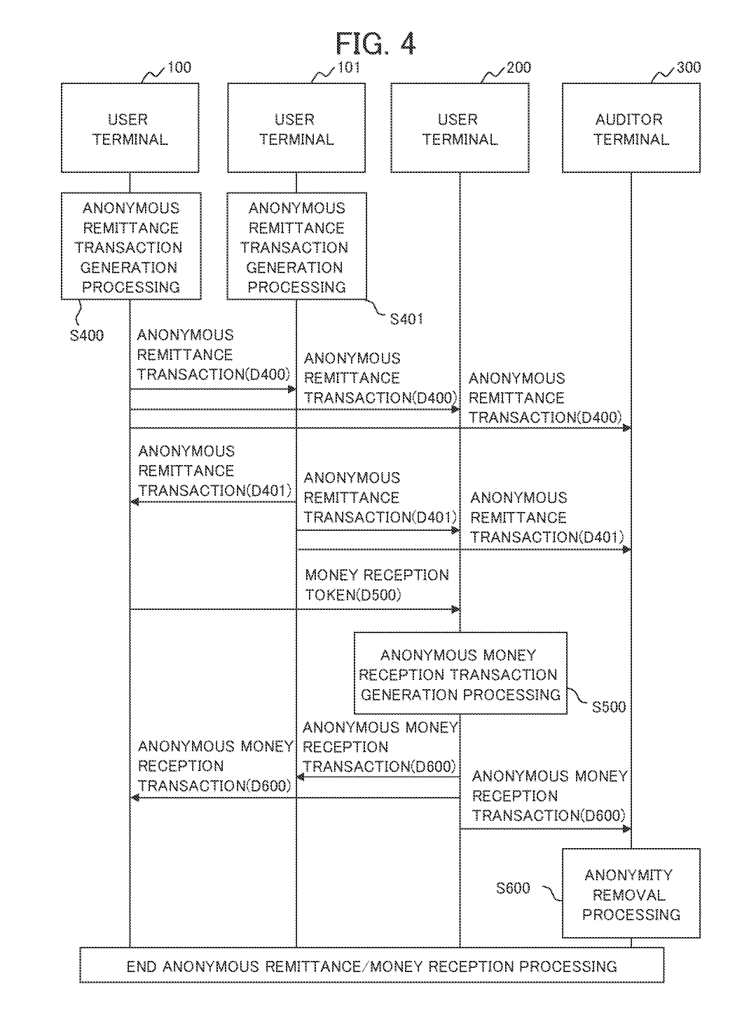

FIG. 4 is a sequence diagram for illustrating an example of processing of data transmission/reception and each program in remittance and money reception processing in the anonymous remittance system with an audit function. In the following description, reception of remitted money is represented by “money reception”.

In the first embodiment, there is exemplified processing at a time when the user terminal 100 and the user terminal 101 generate and broadcast anonymous remittance transaction, the user terminal 100 passes a money reception token to the user terminal 200 serving as a remittance destination, and the user terminal 200 uses the money reception token received from the user terminal 100 to receive money anonymously.

Further, there is exemplified a method of grasping, by the auditor terminal 300, the fact that the user terminal 100 has remitted money to the user terminal 200 at the time of anonymous remittance and money reception processing.

First, the user terminal 100 executes anonymous remittance transaction generation processing to generate anonymous remittance transaction (D400) and a money reception token (D500) (Step S400).

Next, the user terminal 101 similarly executes the anonymous remittance transaction generation processing to generate anonymous remittance transaction (D401) and a money reception token (D501) (Step S401).

Next, the user terminal 100 transmits (broadcasts) the anonymous remittance transaction (D400) generated in Step S400 to the user terminal 101, the user terminal 200, and the auditor terminal 300.

Next, the user terminal 101 transmits (broadcasts) the anonymous remittance transaction (D401) generated in Step S401 to the user terminal 100, the user terminal 200, and the auditor terminal 300.

Next, the user terminal 100 transmits the money reception token (D500) generated in Step S400 to the user terminal 200. The money reception token (D500) is required to be transmitted to only the user terminal 200 serving as the remittance destination.

Next, the user terminal 200 uses the received money reception token (D500) to execute anonymous money reception transaction generation processing, to thereby generate anonymous money reception transaction (D600) (Step S500).

Next, the user terminal 200 transmits (broadcasts) the anonymous money reception transaction (D600) generated in Step S500 to the user terminal 100, the user terminal 101, and the auditor terminal 300. With this processing, the user terminal 200 verifies that the user terminal 200 is a valid recipient of the anonymous remittance transaction (D400), and acquires an electronic value specified by the anonymous remittance transaction (D400) (e.g., virtual currency and electronic money). The processing of anonymous money reception transaction (D600) is similar to that of Non-Patent Literature 2, and thus a description thereof is omitted here.

Next, the auditor terminal 300 executes anonymity removal processing (described later) having the received anonymous remittance transaction (D400), anonymous remittance transaction (D401), and anonymous money reception transaction (D600) as its input, to thereby grasp the fact that the user terminal 100 has remitted money to the user terminal 200 (S600), and finish the anonymous remittance/money reception processing.

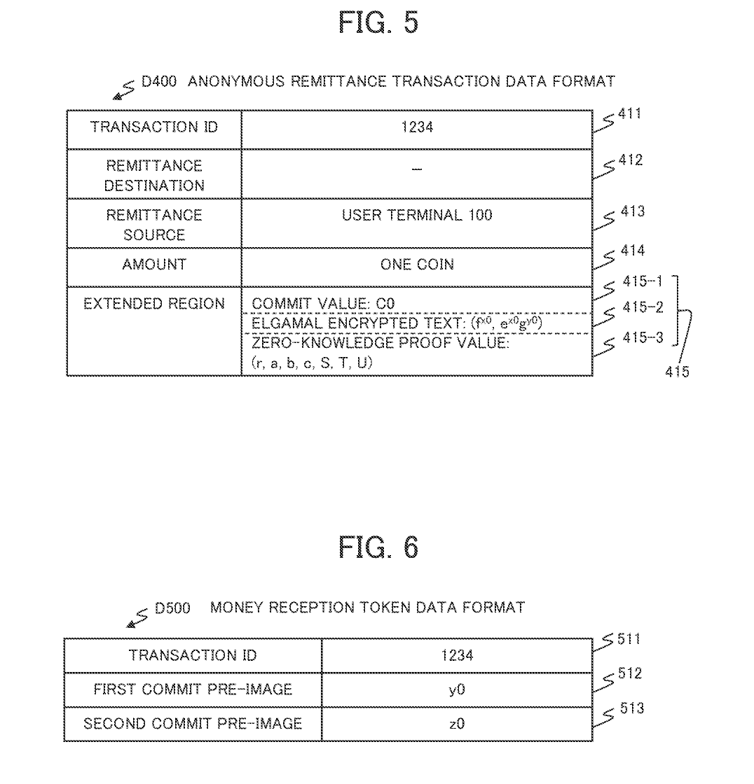

FIG. 5 is a table for showing an exemplary data format of the anonymous remittance transaction (D400). As shown in FIG. 5, the anonymous remittance transaction (D400) contains five types of data fields, namely, a transaction ID 411 for storing an identifier uniquely identifying remittance transaction, a remittance destination 412, a remittance source 413 for storing the identifier of a remittance source, an amount 414 for storing the value of electronic value to be remitted, and an extended region 415.

In the shown example, the transaction ID 411 indicates “1234”, the remittance destination 412 indicates “-” (blank character) for securing anonymous remittance, the remittance source 413 indicates the user terminal 100, and the amount 414 indicates one coin. The extended region 415 stores a commit value 415-1, an ElGamal encrypted text 415-2, and a zero-knowledge proof value 415-3. The zero-knowledge proof value 415-3 indicates the fact (validity) that a discrete logarithm value having a public system parameter h of C0g^{-y0} as its base for the commit value C0 is known.

In the shown example, “C0” is stored as the commit value 415-1, an encrypted text M=(f^{x0}, e^{x0}, g^{y0}) of the plain text g^{y0} obtained by the public key e of the auditor terminal 300 is stored as the ElGamal encrypted text 415-2, and (r, a, b, c, S, T, U) is stored as the zero-knowledge proof value 415-3. Details of each value of the extended region 415 are described later.

The anonymous remittance transaction (D401) generated by the user terminal 101 has the same data format, and the commit value 415-1 of the anonymous remittance transaction (D401) is represented by “C1” in the following.

FIG. 6 is a table for showing an exemplary data format of the money reception token (D500). As shown in FIG. 6, the money reception token (D500) contains three data fields, namely, a transaction ID 511 having the same set value as that of the transaction ID 411 of the anonymous remittance transaction (D400), a first commit pre-image (or first pre-image) 512, and a second commit pre-image (or second pre-image) 513.

In the example of FIG. 6, the money reception token (D500) for the anonymous remittance transaction (D400) of FIG. 5 has the transaction ID 511 of “1234”, the first commit pre-image 512 of “y0”, and the second commit pre-image 513 of “z0”. As a result, the value g^{y0}h^{z0} matches the commit value C0 of the anonymous remittance transaction (D400) (C0=g^{y0}h^{z0}).

With this, only the user terminal 200, which receives the money reception token (D500) and generates money reception transaction, can receive the remittance transaction (D400) in a valid manner.

The money reception token (D500) is desired to be transferred to the user terminal 200 of the remittance destination by, for example, a P2P network that is different from a network for transmitting the anonymous remittance transaction (D400).

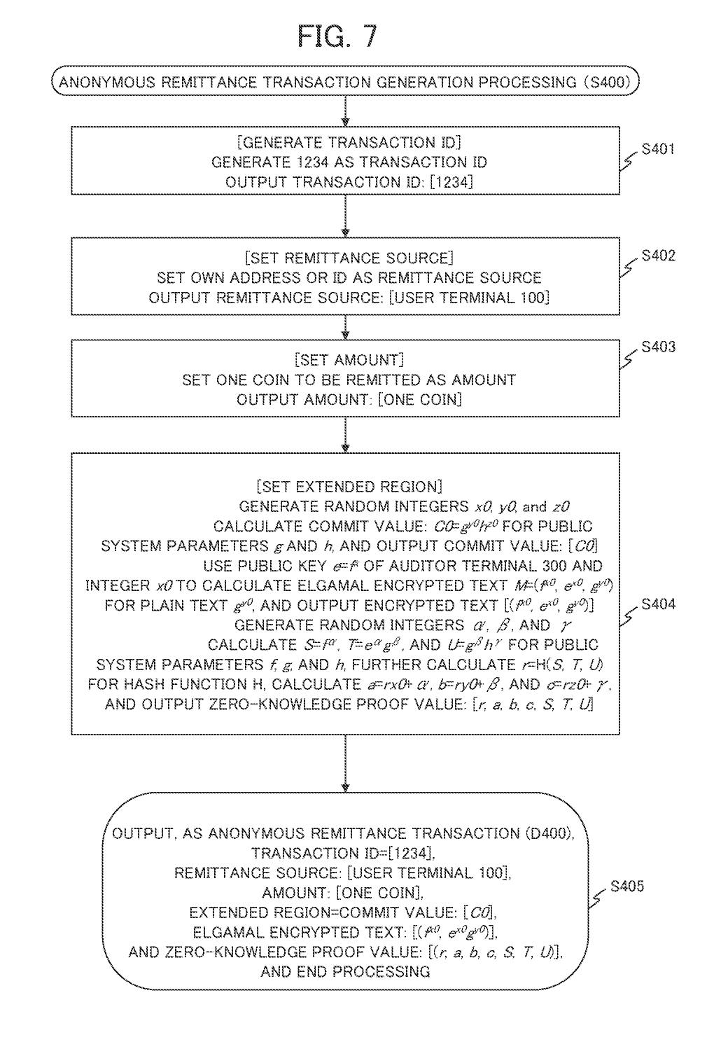

FIG. 7 is a flowchart for illustrating details of the anonymous remittance transaction generation processing (S400). First, the user terminal 100 generates the unique transaction ID 411 different from those of all the transactions generated in the past as “1234”, and outputs the transaction ID 411: [1234] (Step S401).

Next, the user terminal 100 sets the own address or the identifier, for example, the ID, as the remittance source 413, and outputs the remittance source 413: [user terminal 100] (Step S402).

Next, the user terminal 100 sets one coin to be remitted as the amount 414, and outputs the amount 414: [one coin] (Step S403).

Next, the user terminal 100 generates random integers x0, y0, and z0, calculates the commit value 415-1: C0=g^{y0}h^{z0} for the public system parameters g and h, and outputs the commit value 415-1: [C0].

Further, the user terminal 100 uses the public key e=f^{x} of the auditor terminal 300 and the integer x0 to calculate the ElGamal encrypted text M=(f^{x0}, e^{x0}, g^{y0}) for the plain text g^{y0}, and outputs the ElGamal encrypted text 415-2: [(f^{x0}, e^{x0}, g^{y0})].

Further, the user terminal 100 generates random integers α, β, and γ, and calculates S=f^{α}, T=e^{α}g^{β}, and U=g^{β}h^{γ} for the public system parameters f, g, and h.

Further, the user terminal 100 calculates r=H(S, T, U) for the hash function H, calculates a=rx0+α, b=ry0+β, and c=rz0+γ, and outputs the zero-knowledge proof value 415-3: [r, a, b, c, S, T, U] (Step S404).

Next, the user terminal 100 generates transaction data (D400) in which the transaction ID 411: [1234] output in Step S401 is input to the transaction ID field, the remittance source 413: [user terminal 100] output in Step S402 is input to the remittance source field, the amount 414: [one coin] output in Step S403 is input to the amount field, and the commit value 415-1: [C0], the ElGamal encrypted text 415-2: [(f^{x0}, e^{x0}, g^{y0})], and the zero-knowledge proof value 415-3: [(r, a, b, c, S, T, U)], which are output in Step S404, are input to an extended region field, and then ends the anonymous remittance transaction generation processing (Step S400) (Step S405).

Determination of the validity of the zero-knowledge proof value 415-3: [(r, a, b, c, S, T, U)] includes the following two steps.

Step 1: It is determined whether r=H(S, T, U) is satisfied for r, S, T, U of the zero-knowledge proof value [r, a, b, c, S, T, U] and the hash function H.

Step 2: It is determined whether three equations, namely, f^{a}=(f^{x0})^{r}S, e^{a}g^{b}=(e^{x0}g^{y0})^{r}T, and g^{b}h^{c}=(C0)^{r}U are satisfied for the public system parameters f, g, and h, the public key e of the auditor terminal 300, the commit value 415-1: [C0], the ElGamal encrypted text 415-2: [(f^{x0}, e^{x0}g^{y0})], and r, a, b, c of the) zero-knowledge proof value 415-3: [r, a, b, c, S, T, U].

The zero-knowledge proof value 415-3: [(r, a, b, c, S, T, U)] is determined to be valid only when the above-mentioned two steps are satisfied. Further, this processing of determining the validity may be executed by any user terminal (e.g., user terminal 200) having received the anonymous remittance transaction (D400), and the user terminal may transmit the result to other terminals.

With the above-mentioned processing, the user terminal 100 (101) can generate the anonymous remittance transaction (D400) having the added ElGamal encrypted text 415-2 and zero-knowledge proof value 415-3 in addition to the commit value 415-1 having a blank character as its remittance destination.

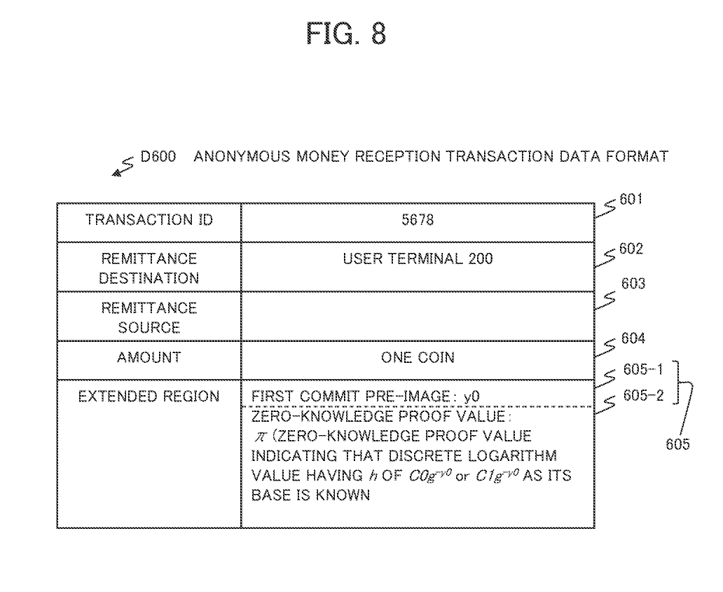

FIG. 8 is a table for showing an exemplary data format of the anonymous money reception transaction (D600). As shown in FIG. 8, the anonymous money reception transaction (D600) contains five types of data fields, namely, a transaction ID 601 for uniquely identifying money reception transaction, a remittance destination 602, a remittance source 603, an amount 604, and an extended region 605. The extended region 605 contains a first commit pre-image 605-1 and a zero-knowledge proof value 605-2.

In the shown example, “5678” is set in the transaction ID 601, the identifier of the own user terminal 200 is stored in the remittance destination 602, “-” (blank character) is input in the remittance source 603, and “one coin” is input in the amount 604.

The zero-knowledge proof value 605-2 indicating that a discrete logarithm value having the public system parameter h of C0g^{-y0} or C1g^{-y0} as its base for the first commit pre-image 605-1: y0, the commit value C0 of the anonymous remittance transaction (D400), and the commit value C1 of the anonymous remittance transaction (D401) is known is set in the extended region 605.

In the first embodiment, the user terminal 200 receives the money reception token (D500) from the user terminal 100, and thus the zero-knowledge proof value 605-2 indicating that a discrete logarithm value having the public system parameter h of C0g^{-y0} as its base for the commit value C0 of the anonymous remittance transaction (D400) is known is set.

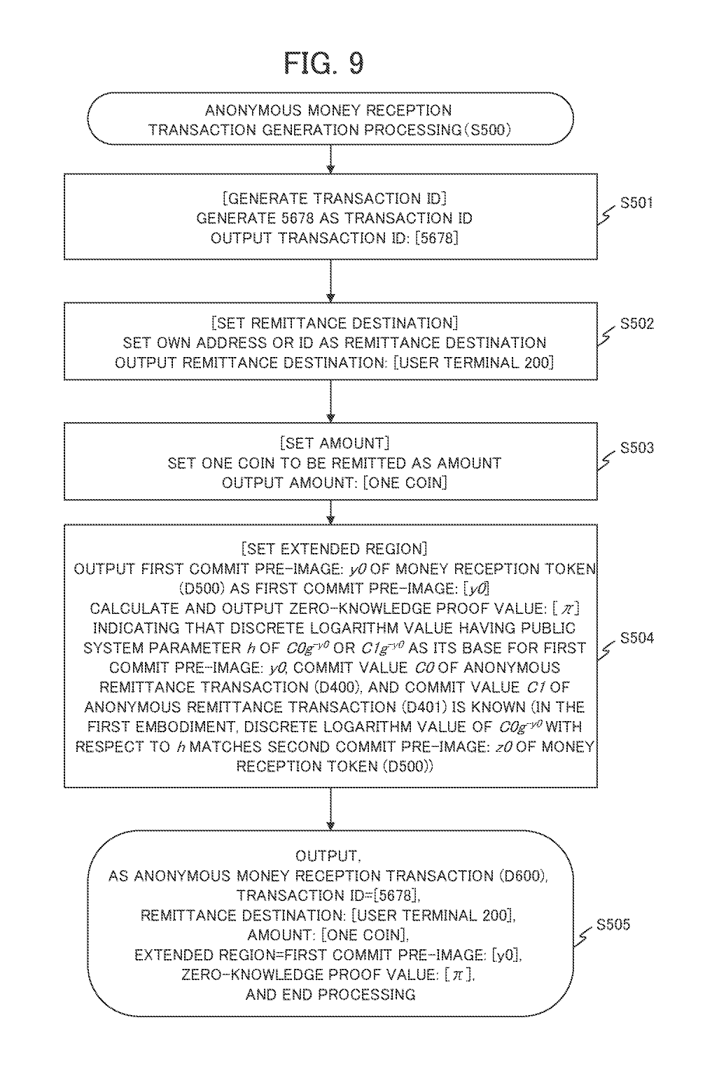

FIG. 9 is a flowchart for illustrating details of the anonymous money reception transaction generation processing (S500). This processing is executed by the user terminal 200 having received the anonymous remittance transaction (D400) and the money reception token (D500).

First, the user terminal 200 generates “5678” as a unique transaction ID 601, which is different from all the transaction generated in the past, and outputs the transaction ID 601: [5678] (Step S501).

Next, the user terminal 200 sets the own address or ID as the remittance destination 602, and outputs the remittance destination 602: [user terminal 200] (Step S502). The blank value=“-” is set in the remittance source 603 because the anonymous remittance transaction (D400) is executed. Further, the remittance destination 602 of the anonymous money reception transaction (D600) is the user terminal 200 itself to receive an electronic value.

Next, the user terminal 200 sets “one coin” in the amount 604 to be remitted, and outputs the amount 604: [one coin] (Step S503).

The user terminal 200 outputs the first commit pre-image 512: y0 of the money reception token (D500) as the first commit pre-image 605-1: [y0], and calculates and outputs the zero-knowledge proof value 605-2: [ π] indicating the fact that a discrete logarithm value having the public system parameter h of C0g^{-y0} or C1g^{-y0} as its base for the first commit pre-image: y0, the commit value C0 of the anonymous remittance transaction (D400), and the commit value C1 of the anonymous remittance transaction (D401) is known (Step S504).

In the first embodiment, the discrete logarithm value of C0g^{-y0} with respect to h matches the second commit pre-image: z0 of the money reception token (D500), and thus the user terminal 200 can calculate the zero-knowledge proof value: [π]. Algorithms described in Non-Patent Literature 2 and Non-Patent Literature 3 may be used as an algorithm for calculating the zero-knowledge proof value: [π].

Through the above-mentioned processing, the user terminal 200, which has received the money reception token (D500), can calculate the zero-knowledge proof value 605-2: π of the anonymous money reception transaction (D600) based on the first commit pre-image 512=“y0” and the second commit pre-image 513=“z0” contained in the money reception token (D500).

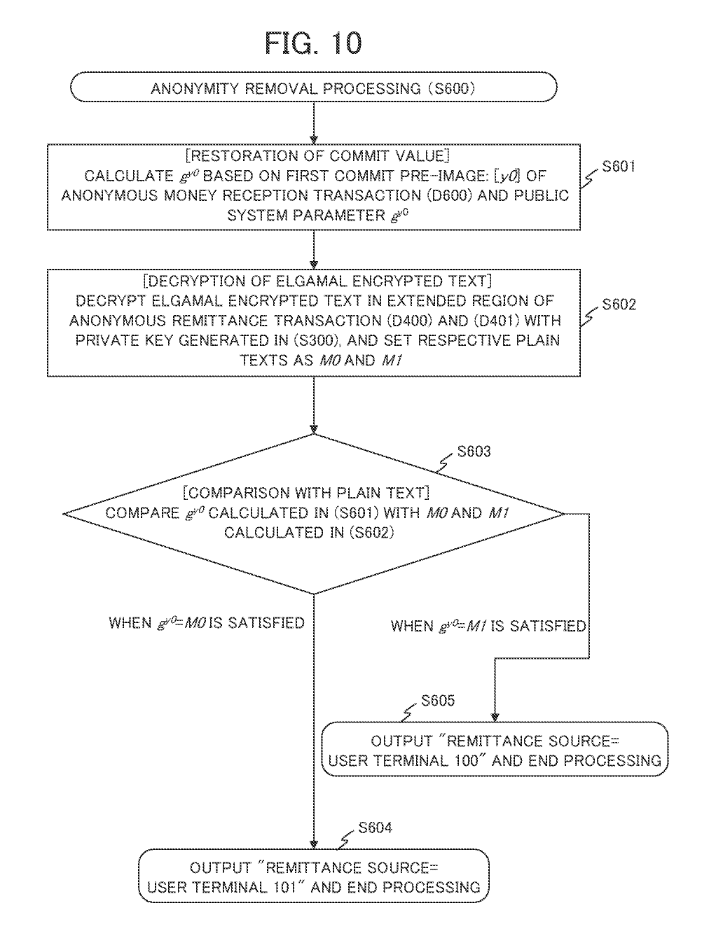

FIG. 10 is a flowchart for illustrating details of the anonymity removal processing (Step S600). This processing can be executed by the auditor terminal 300 as appropriate.

First, the auditor terminal 300 calculates a plain text (first plain text) g^{y0} based on the first commit pre-image 605-1: [y0] of the received anonymous money reception transaction (D600) and the public system parameter g (Step S601).

The user terminals 101 and 200 and the auditor terminal 300 acquires the public system parameter g in advance. The commit value is C0=g^{y0}h^{z0}, and thus the auditor terminal 300 can restore the commit value C0 based on the calculated g^{y0}.

Next, the auditor terminal 300 decrypts the ElGamal encrypted text 415-2 in the extended region 415 of the anonymous remittance transaction (D400) and (D401) with the private key generated in Step S300 of FIG. 3, and sets respective plain texts (second plain texts) as M0 and M1 (Step S602).

Next, the auditor terminal 300 compares the first plain text g^{y0} calculated in Step S601 with the second plain texts M0 and M1 calculated in Step S602 (Step S603). When the first plain text g^{y0} is equal to the second plain text M0, the auditor terminal 300 advances the processing to Step S604, and outputs “remittance source 413=user terminal 100” for “remittance destination=user terminal 200”.

Meanwhile, when the first plain text g^{y0} is equal to the second plain text M1, the auditor terminal 300 advances the processing to Step S605, and outputs “remittance source 413=user terminal 100” for “remittance destination=user terminal 200”.

With the above-mentioned processing, the auditor terminal 300 decrypts the ElGamal encrypted text 415-2 of the anonymous remittance transaction, which has been encrypted with the own public key e, with the private key, sets the decrypted ElGamal encrypted text 415-2 as a plain text M, and calculates a plain text (first plain text) g^{y0} based on the first commit pre-image 605-1: [y0] of the anonymous money reception transaction (D600). Then, the auditor terminal 300 identifies the remittance source 413 of the plain text (second plain text) M matching the plain text g^{y0}, and associates the remittance source 413 with the remittance destination 602 (recipient user terminal 200) of the anonymous money reception transaction, to thereby be able to generate a remittance history.

With this, the auditor terminal 300 can identify the remittance source 413 and the remittance destination 602 based on the anonymous remittance transaction D400 and the anonymous money reception transaction D600, and generate and trace (validate) a remittance history.

As described above, according to the first embodiment, it is possible to anonymize transaction and remit money for the user terminal 200 (P2P network node) other than the auditor terminal 300. At the same time, the auditor terminal 300 can generate and trace, for example, a remittance history by removing the anonymity of the transaction. Further, the auditor terminal 300 does not have an authority to stop remittance itself or freeze an account unlike the case of a central organization, for example, an existing bank. Thus, the freedom of remittance can be secured.

Further, the zero-knowledge proof values 415-3 and 605-2 indicating the validity of secret information for tracing the remittance history are added to the anonymous remittance transaction (anonymous money reception transaction) so that the validity of the secret information for tracing all the user terminals 100, 101, and 200 can be determined. As a result, a special authority is not required for validating the validity and integrity of transaction. Therefore, a centralized organization or other organizations for validating the validity and integrity of remittance processing is not required, and thus it is possible to maintain the remittance system at low fees.

The auditor terminal 300 can function as an auditing apparatus for removing the anonymity of anonymous remittance transaction between user terminals and monitoring or auditing the remittance history.

This invention is not limited to the above-mentioned first embodiment, and various modifications can be made within the scope of the gist thereof.

For example, in FIG. 4 of the first embodiment, the two terminals, namely, the user terminal 100 and the user terminal 101 generate the anonymous remittance transaction (D400 and D401). However, three or more terminals may generate the anonymous remittance transaction.

Further, in FIG. 5 and FIG. 8 in the first embodiment, the amount: [one coin] is exemplified as the amount, but the amount field may take other values.

Further, in the anonymous remittance transaction data format of FIG. 5 in the first embodiment, the zero-knowledge proof value within the extended region is set to [(r, a, b, c, S, T, U)]. However, the values S, T, U are not necessarily required to be included, and those values may be calculated based on f^{a}/)(f^{x0})^{r}=S, e^{a}g^{b}/(e^{x0}g^{y0})r=T, g^{b}h^{c}/(C0)^{r}=U, and other data.

### Second Embodiment

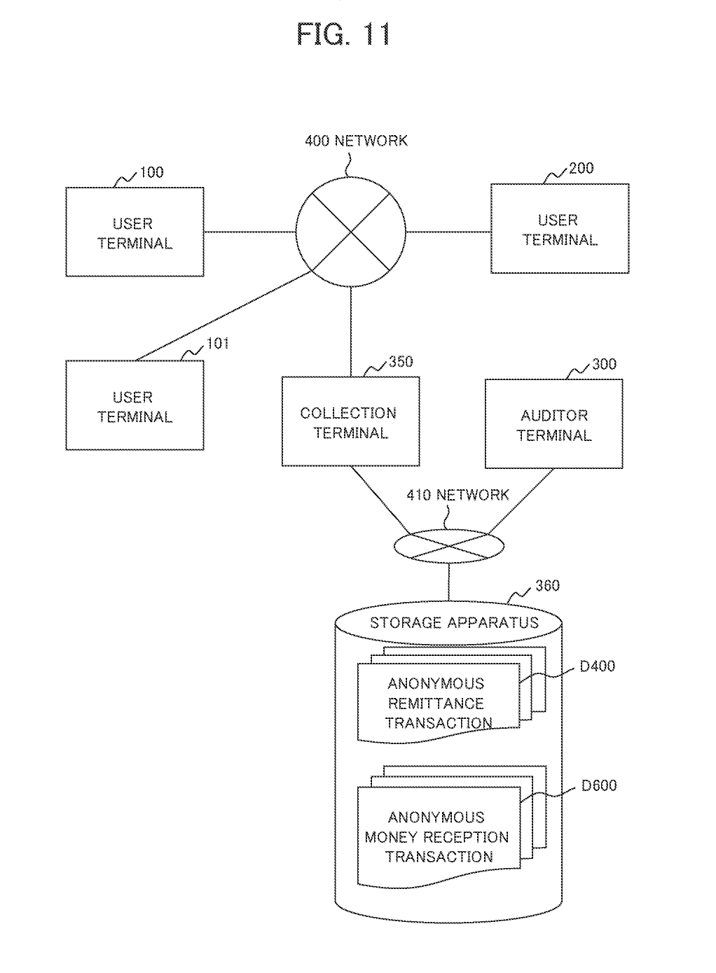

FIG. 11 is a block diagram for illustrating an example of an anonymous remittance system with an audit function in a second embodiment of this invention. In the second embodiment, a collection terminal 350 is coupled to a network 400, and collects the anonymous remittance transaction D400 transmitted among the user terminals 100, 101, and 200 and the anonymous money reception transaction D600, and stores the collected anonymous remittance transaction D400 and anonymous money reception transaction D600 into a storage apparatus 360. The auditor terminal 300 traces the remittance history based on the anonymous remittance transaction D400 and the anonymous money reception transaction D600 read out from the storage apparatus 360.

In the illustrated example, the collection terminal 350, the auditor terminal 300, and the storage apparatus 360 are coupled to a network 410. Other components are similar to those of the first embodiment. The network 400 and the network 410 may be coupled to each other.

In the second embodiment, the auditor terminal 300 is not required to collect the anonymous remittance transaction D400 and the anonymous money reception transaction D600, and thus the resource of the computer can be allocated to the processing (Step S600) of removing the anonymity in a dedicated manner. With this, the auditor terminal 300 can quickly remove the anonymities of the anonymous remittance transaction D400 and the anonymous money reception transaction D600 received from the storage apparatus 360, identify remittance source information (remittance source 413) and remittance destination information (remittance destination 602), and smoothly trace the remittance history.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

What is claimed is:

1. An auditing equipment, comprising a processor and a memory, the processor being configured to:
receive first transaction including: remittance source information; an electronic value; and an encrypted text;
receive second transaction including: remittance destination information; the electronic value; and a first pre-image;
calculate a first plain text based on a predetermined parameter and the first pre-image of the second transaction;
calculate a second plain text by decrypting the encrypted text of the first transaction; and
compare the first plain text with the second plain text to associate the remittance source information of the first transaction with the remittance destination information of the second transaction when the first plain text matches the second plain text.

2. The auditing equipment according to claim 1,
wherein the encrypted text of the first transaction is obtained by encrypting the first pre-image with a public key, and
wherein the processor is configured to decrypt the encrypted text of the first transaction with a private key corresponding to the public key to calculate the second plain text.

3. The auditing equipment according to claim 1, wherein the first transaction comprises a zero-knowledge proof value for verifying validity of the first pre-image.

4. The auditing equipment according to claim 2, wherein the encrypted text comprises an ElGamal encrypted text.

5. An anonymous remittance method with an audit function, for auditing, by an auditing equipment, remittance transaction transmitted from a first computer comprising a processor and a memory to a second computer, the anonymous remittance method comprising:
a first step of transmitting, by the first computer, first transaction including: remittance source information; an electronic value; and an encrypted text;
a second step of receiving, by the second computer and the auditing equipment, the first transaction;
a third step of transmitting, by the second computer, second transaction including: remittance destination information; the electronic value; and a first pre-image;
a fourth step of receiving, by the auditing equipment, the second transaction;
a fifth step of calculating, by the auditing equipment, a first plain text based on a predetermined parameter and the first pre-image of the second transaction;
a sixth step of calculating, by the auditing equipment, a second plain text by decrypting the encrypted text of the first transaction; and
a seventh step of comparing, by the auditing equipment, the first plain text with the second plain text to associate the remittance source information of the first transaction with the remittance destination information of the second transaction when the first plain text matches the second plain text.

6. The anonymous remittance method with an audit function according to claim 5,
wherein the first step comprises receiving, by the first computer, a public key from the auditing equipment, and encrypting the first pre-image with the public key to generate the encrypted text, and
wherein the sixth step comprises decrypting, by the auditing equipment, the encrypted text of the first transaction with a private key corresponding to the public key to calculate the second plain text.

7. The anonymous remittance method with an audit function according to claim 5, wherein the first transaction comprises a zero-knowledge proof value for verifying validity of the first pre-image.

8. The anonymous remittance method with an audit function according to claim 6, wherein the encrypted text comprises an ElGamal encrypted text.

9. A non-transitory computer-readable storage medium having stored thereon a program for controlling a computer comprising a processor and a memory, the program causing the computer to execute:
a first step of receiving first transaction including: remittance source information; an electronic value; and an encrypted text;
a second step of receiving second transaction including: remittance destination information; the electronic value; and a first pre-image;
a third step of calculating a first plain text based on a predetermined parameter and the first pre-image of the second transaction;
a fourth step of calculating a second plain text by decrypting the encrypted text of the first transaction; and
a fifth step of comparing the first plain text with the second plain text to associate the remittance source information of the first transaction with the remittance destination information of the second transaction when the first plain text matches the second plain text.

10. The non-transitory computer-readable storage medium according to claim 9,
wherein the encrypted text of the first transaction is obtained by encrypting the first pre-image with a public key, and
wherein the fourth step includes decrypting the encrypted text of the first transaction with a private key corresponding to the public key to calculate the second plain text.

11. The non-transitory computer-readable storage medium according to claim 9, wherein the first transaction comprises a zero-knowledge proof value for verifying validity of the first pre-image.

12. The non-transitory computer-readable storage medium according to claim 10, wherein the encrypted text comprises an ElGamal encrypted text.
